(19) United States
(12) Patent Application Publication
(10) Pub. No.: US 2025/0391186 A1
(43) Pub. Date: Dec. 25, 2025

(54) VEHICLE MILEAGE RECOGNITION METHOD AND APPARATUS

(71) Applicants: HYUNDAI MOTOR COMPANY, Seoul (KR); Kia Corporation, Seoul (KR)

(72) Inventors: Taewoo KANG, Hwaseong-si (KR); Minkooc WEE, Hwaseong-si (KR); Heeoh JANG, Hwaseong-si (KR); Jin Young JUNG, Hwaseong-si (KR)

(21) Appl. No.: 18/961,006

(22) Filed: Nov. 26, 2024

(30) Foreign Application Priority Data
Jun. 21, 2024 (KR) 10-2024-0080876

(51) Int. Cl. G06V 30/10; G06T 3/60; G06V 10/25; G06V 20/62

(52) U.S. Cl. CPC G06V 30/10; G06T 3/60; G06V 10/25; G06V 20/62

(57) ABSTRACT

A vehicle mileage recognition method includes: obtaining an input image including a vehicle mileage, where the input image corresponds to a recognition target image; detecting a text region from the recognition target image; extracting a text image in the text region; arranging the text image in an upright position; modifying an appearance or structure of the text image that is arranged in the upright position; recognizing, within a modified text image, a text by using an OCR model; detecting, based on the text that is recognized by using the OCR model, a recognition target text; determining, based on the recognition target text, a rotation angle of the recognition target image; and recognizing, based on the rotation angle, a final text from the recognition target text and determining the final text as the vehicle mileage.

### CROSS-REFERENCE TO RELATED APPLICATION

This application claims priority to and the benefit of Korean Patent Application No. 10-2024-0080876, filed on Jun. 21, 2024, the disclosure of which is incorporated herein by reference in its entirety.

### TECHNICAL FIELD

The present disclosure relates to a vehicle mileage recognition method and apparatus.

### BACKGROUND

Object detection and recognition can be important steps in Optical Character Recognition (OCR), which may involve the process of identifying and locating text or characters in an image or document. Object detection may identify the location of an object and define its boundaries by using a bounding box, while object recognition may convert the object's content into readable text.

Object detection and recognition may convert images or scanned documents into machine-readable text in an editable and searchable format.

Object detection and recognition in OCR based on deep learning technology may be useful in various application fields such as document digitization and data extraction.

Rotation, distortion, or noise may frequently affect the object input into the recognition model, such as OCR. Accordingly, when the initially detected object is immediately input to the recognition model, a lower recognition rate may occur.

### SUMMARY

The present disclosure attempts to provide a vehicle mileage recognizing method and apparatus capable of improving the vehicle mileage recognition rate through OCR by refining the input data through pre-processing and/or post-processing.

A vehicle mileage recognizing method can include obtaining an input image photographing a mileage as a recognition target image, detecting a text region from the recognition target image, extracting a text image in the detected text region and arranging the extracted text image in a positive direction, converting a form of the text image arranged in the positive direction, recognizing a text by using an OCR model with respect to the text image of which the form has been converted, detecting a recognition target text through post-processing with respect to the recognized text, confirming a rotation angle of the recognition target image based on the recognition target text, and recognizing a final text selected from the recognition target text in consideration of the rotation angle and determining the recognized final text as the mileage.

The obtaining the recognition target image can include obtaining at least one among a plurality of recognition target images obtained by rotating the input image from 0 degree to 270 degrees by 90 degrees unit.

The detecting the text region from the recognition target image can include detecting the text region based on the Character Region Awareness for Text Detection (CRAFT) model.

The extracting the text image in the detected text region and arrange the extracted text image in the positive direction can include disposing the text image in the positive direction or a positive angle by using a perspective transformation.

The converting the form of the text image arranged in the positive direction include converting the text image into black and white by using a style transfer.

The recognizing a text by using the OCR model with respect to the text image include recognizing the text by using a plurality of OCR models, and the plurality of OCR models can include 7-segment font dedicated model.

The detecting the recognition target text through post-processing with respect to the text can include detecting the recognition target text by using a text pre-processing method (e.g., text pre-processing technique), a longest text pre-processing method (e.g., longest text pre-processing technique) and a box size outlier pre-processing method (e.g., box size outlier pre-processing technique) as the post process.

The longest text pre-processing method can be to remove a remaining text excluding a text having a specific length representing the mileage among the texts.

The confirming the rotation angle of the recognition target image based on the recognition target text can include, based on the text region of a rectangular shape of a longest length including the recognition target text, obtaining distances between one vertex and remaining vertices in the text region, and selecting a longest line among remaining lines excluding diagonal lines, and determining the rotation angle of the recognition target image, as 90 degrees, when a smaller angle among angles between the selected longest line and the x-axis parallel line is 45 degrees or more and 90 degrees or less.

The recognizing the final text selected from the recognition target text in consideration of the rotation angle, and determine the recognized final text as the mileage can include determining the recognition target text as a final recognition target text, when the recognition target text can include a specific character, representing the mileage, and re-determining a longest text among texts including the specific character, as the final recognition target text, when the recognition target text does not include the specific character, and comparing the final recognition target text with an input mileage inputted by a user, and recognizing a most similar final recognition target text as the final text, and determine the recognized text as the mileage.

A vehicle mileage recognizing apparatus can include a text detection unit configured to detect a text region from a recognition target image obtained by rotating an input image photographing a mileage, a pre-processing unit configured to extract a text image in the detected text region and arrange the extracted text image in a positive direction, and convert a form of the text image arranged in the positive direction, a text recognition unit configured to recognize a text by using an OCR model with respect to the text image of which the form has been converted, a post-processor configured to detect a recognition target text through post-processing with respect to the recognized text, and confirm a rotation angle of the recognition target image based on the recognition target text, and a mileage determiner configured to recognize a final text selected from the recognition target text in consideration of the rotation angle, and determine the recognized final text as the mileage.

The text detection unit can be configured to obtain at least one among a plurality of recognition target images obtained by rotating the input image from 0 degree to 270 degrees by 90 degrees unit.

The text detection unit can be configured to a detect the text region based on the Character Region Awareness for Text Detection (CRAFT) model.

The pre-processing unit can be configured to dispose the text image in the positive direction or a positive angle by using a perspective transformation.

The pre-processing unit can be configured to convert the text image into black and white by using a style transfer.

The text recognition unit can be configured to recognize the text by using a plurality of OCR models including 7-segment font dedicated model.

The post-processor can be configured to detect the recognition target text by using a text pre-processing method, a longest text pre-processing method and a box size outlier pre-processing method as the post process.

The post-processor can be the longest text pre-processing method can be to remove a remaining text excluding a text having a specific length representing the mileage among the texts.

The post-processor can be configured to, based on the text region of a rectangular shape of a longest length including the recognition target text, obtain distances between one vertex and remaining vertices in the text region, and select a longest line among remaining lines excluding diagonal lines, and determine the rotation angle of the recognition target image, as 90 degrees, when a smaller angle among angles between the selected longest line and the x-axis parallel line is 45 degrees or more and 90 degrees or less.

The mileage determiner can be configured to determine the recognition target text as a final recognition target text when the recognition target text can include a specific character, representing the mileage, and exclude the corresponding text, and re-determine a longest text among texts including the specific character as the final recognition target text when the recognition target text does not include the specific character, and compare the final recognition target text with an input mileage inputted by a user, recognize a most similar final recognition target text as the final text, and determine the recognized text as the mileage.

A vehicle mileage recognizing method and apparatus according to an implementation can improve the vehicle mileage recognition rate through OCR by refining the input data through pre-processing and/or post-processing.

### BRIEF DESCRIPTION OF THE DRAWINGS

FIG. 1 shows a screen to recognize mileage in vehicle according to an implementation.

FIG. 2 is a block diagram of a vehicle mileage recognizing apparatus according to an implementation.

FIG. 3 is a flowchart of a vehicle mileage recognizing method according to an implementation.

FIG. 4 is a flowchart of a vehicle mileage recognizing method according to an implementation.

FIG. 5 is a flowchart of a vehicle mileage recognizing method according to an implementation.

FIG. 6 is a flowchart of a vehicle mileage recognizing method according to an implementation.

FIGS. 7A-7D are example drawings illustrating a vehicle mileage recognizing method according to an implementation.

FIG. 8 is drawing for explaining a computing device according to an implementation.

### DETAILED DESCRIPTION

Implementations of the disclosure will be described more fully hereinafter with reference to the accompanying drawings such that a person skill in the art can easily implement the implementations. As those skilled in the art would realize, the described implementations can be modified in various different ways, all without departing from the spirit or scope of the present disclosure. In order to clarify the present disclosure, parts that are not related to the description will be omitted, and the same elements or equivalents are referred to with the same reference numerals throughout the specification.

Hereinafter, implementations of the present disclosure will be described with reference to the drawings.

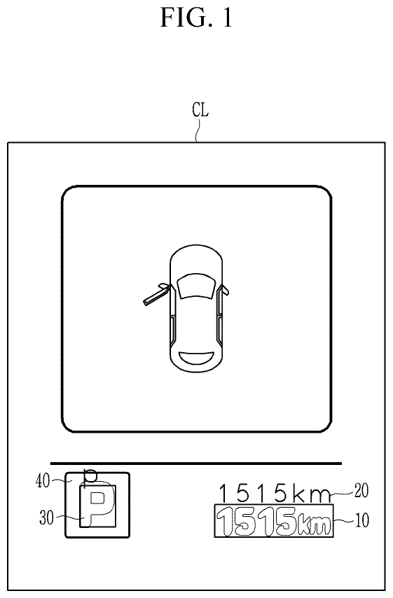

FIG. 1 shows a screen to recognize mileage in vehicle according to an implementation. FIG. 1 can represent a screen displayed in the cluster of the vehicle or an image photographing the screen displayed in the cluster.

In FIG. 1, typically, the mileage of the vehicle can be displayed on a vehicle cluster screen CL. A mileage 10 can appear as 1515 km, and an OCR text recognition result 20 can appear as 1515 km.

A vehicle mileage recognizing apparatus can detect and recognize the mileage 10 displayed on a cluster screen image CL through an artificial intelligence-based OCR.

For example, the vehicle mileage recognizing apparatus can detect the mileage 10 displayed in the cluster screen image CL as an object, and define the boundary by a bounding box. The vehicle mileage recognizing apparatus can convert the mileage 10 detected within the image into a readable text 20.

The vehicle mileage recognizing apparatus can detect all text regions from the cluster screen image CL. The text region in FIG. 1 can be defined as the mileage 10 and a vehicle state indication 30.

The vehicle mileage recognizing apparatus can extract texts 20 and 40 from the text regions 10 and 30 displaying the mileage 10 and the vehicle state indication 30, respectively.

The vehicle mileage recognizing apparatus can detect a recognition target text 20 representing the mileage 10 among the extracted texts 20 and 40.

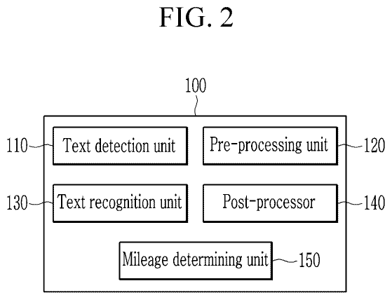

During this process, the vehicle mileage recognizing apparatus can improve the recognition rate with respect to the mileage through pre-processing and/or post-processing with respect to the object detected during the process of mileage recognition. More detailed description will be made with reference to FIG. 2 to FIG. 6.

FIG. 2 is a block diagram of the vehicle mileage recognizing apparatus according to an implementation.

Referring to FIG. 2, a vehicle mileage recognizing apparatus 100 can include a text detection unit 110, a pre-processing unit 120, a text recognition unit 130, a post-processor 140 and a mileage determiner 150.

The text detection unit 110 can obtain an input image photographing the mileage as a recognition target image. The text detection unit 110 can rotate the input image, and can obtain the rotated input image as the recognition target image.

The input image can be the cluster screen image CL (see FIG. 1) of the vehicle displaying the mileage 10 (see FIG. 1).

For example, the text detection unit 110 can obtain at least one among a plurality of recognition target images obtained by rotating the input image from 0-degree to 270-degrees by 90-degrees unit.

The recognition target image can include not only the image obtained by rotating the input image but also an un-rotated image.

The text detection unit 110 can detect a text region in the recognition target image. The text detection unit 110 can detect text regions from the plurality of recognition target images, each having a different rotation angle.

The text region can be a rectangular box region. A text image displaying a text including letters and numbers can be disposed within the text region.

The text detection unit 110 can detect the text region based on the Character Region Awareness for Text Detection (CRAFT) model.

Character Region Awareness for Text Detection (CRAFT) model can be a deep learning-based text detection algorithm used to effectively detect the text region from the image.

The pre-processing unit 120 can extract the text image in the detected text region. The text image can be extracted from the text region defined in the recognition target images having a preset rotation angle. Therefore, the text image can have the preset rotation angle.

The pre-processing unit 120 can arrange the extracted text image in a positive direction. Here, the text image can be inclined with the preset rotation angle, and thus, can be offset from the positive direction.

Here, the positive direction can be a direction parallel to an x-axis direction. That is, when arranged in the positive direction, the text image can be arranged parallel to the x-axis direction.

The pre-processing unit 120 can dispose the text image in the positive direction or a positive angle by using a perspective transformation. The positive angle can be an angle of the text image when arranged in the positive direction.

The perspective transformation can be a conversion method of projecting a 3D object to a 2D plane in an image processing and computer vision. The perspective transformation can map the plane of the image into another plane, and simulate the effect that the object is distorted according to the camera angle and the distance.

That is, the pre-processing unit 120 can arrange the text image to be parallel to the x-axis direction by using the perspective transformation.

The pre-processing unit 120 can convert a form of the text image arranged in the positive direction.

The pre-processing unit 120 can convert the form of the text image extracted from the recognition target image into the form for best performance of text recognition through a style transfer.

The style transfer can be the technology of applying the style of one image to another image, in the image processing and computer vision field. The style transfer can by performed, usually by using deep learning, particularly convolution neural network (CNN). The style transfer is creating a new image by applying artistic elements or textures from one image (style image) to another image (content image).

For example, the pre-processing unit 120 can convert the text image to black and white by using the style transfer.

The text recognition unit 130 can recognize a text by using an OCR model with respect to the text image of which the form has been converted.

The optical character recognition (OCR) model can recognize and extract texts from an image. The OCR model can be implemented by deep learning, particularly by combining CNN and RNN.

The text recognition unit 130 can recognize a text by using a plurality of OCR models including a 7-segment font dedicated model. For example, the plurality of OCR models can include the 7-segment font dedicated model and a general font dedicated model.

The 7-segment model font dedicated model can be a model for recognizing a number displayed in a 7-segment display, and can be mainly used for a digital number reader.

The 7-segment display can mean a display device representing numbers and letters by 7 line segments.

The mileage of the cluster screen of the vehicle is usually displayed through a 7-segment display, and accordingly, the text recognition rate of the 7-segment model font dedicated model is high.

The text recognition unit 130 can detect a plurality of text recognition results by using a plurality of models.

The post-processor 140 can detect the recognition target text through post-processing with respect to the recognized texts.

The post-processor 140 can modify and delete an unnecessary candidate group in order to find an accurate mileage from among various mileage candidate groups.

The post-processor 140 can detect the recognition target text by using a text pre-processing method, a longest text pre-processing method and a box size outlier pre-processing method, as a post-processing method.

A text pre-processing method can be a method of remove texts having features having a low possibility of being the mileage.

A longest text pre-processing method can be a method of removing a remaining text excluding a text having a specific length representing mileage among the texts.

A box size outlier pre-processing method can be a method of removing the text region in a specific size or greater or the text region in a specific size or smaller based on the size of the box defining the text region.

The post-processor 140 can confirm the rotation angle of the recognition target image based on the recognition target texts.

The post-processor 140 can confirm whether the image has been rotated based on a text box having a longest numeral.

The post-processor 140 can confirm whether the image has been rotated and calculate the rotation angle.

The post-processor 140 can obtain distances between one vertex and remaining vertices in the text region, based on the text region of a rectangular shape of a longest length including the recognition target text.

The post-processor 140 can select longest line among remaining lines excluding diagonal lines.

When a smaller angle among angles between the selected longest line and the x-axis parallel line is 45 degrees or more and 90-degrees or less, the post-processor 140 can determine the rotation angle of the recognition target image as 90-degrees.

The mileage determiner 150 can recognize a final text selected from the recognition target text in consideration of the rotation angle, and determine the recognition result as the mileage.

The mileage determiner 150 can confirm whether the image input by the user has been input at a normal angle (0-degree rotation) or input while having been rotated by 90 degrees.

The mileage determiner 150 can provide the confirmed rotation angle to the deep learning model for text recognition, and thereby can assist generation of an accurate text recognition result.

When the recognition target text includes a specific character representing the mileage, the mileage determiner 150 can determine the recognition target text as a final recognition target text.

When the recognition target text does not include the specific character, the mileage determiner 150 can re-determine longest text among texts including the specific character as the final recognition target text.

The mileage determiner 150 can compare the final recognition target text with an input mileage inputted by a user, and thereby can recognize a most similar final recognition target text as the final text, and determine the recognized final text as the mileage.

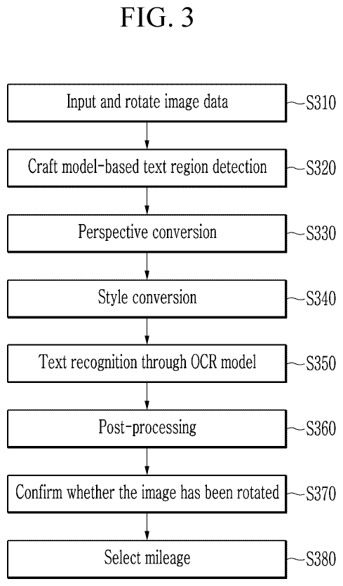

FIG. 3 is a flowchart of a vehicle mileage recognizing method according to an implementation. The vehicle mileage recognizing method can be performed through the vehicle mileage recognizing apparatus 100 (see FIG. 2).

In FIG. 3, the vehicle mileage recognizing apparatus 100 can obtain the input image photographing the mileage as the recognition target image.

At step S310, the vehicle mileage recognizing apparatus 100 can receive and rotate the input image data.

The vehicle mileage recognizing apparatus 100 can obtain at least one among the plurality of recognition target images obtained by rotating the input image from 0 degree to 270 degrees by 90 degrees unit.

The vehicle mileage recognizing apparatus 100 can detect the text region from the recognition target images, respectively.

At step S320, the vehicle mileage recognizing apparatus 100 can detect the text region based on the Character Region Awareness for Text Detection (CRAFT) model.

For example, the vehicle mileage recognizing apparatus 100 can detect a region including texts or numbers in all directions of the recognition target image based on a model trained in advance.

The vehicle mileage recognizing apparatus 100 can mark the detected text region by a green rectangular box.

The vehicle mileage recognizing apparatus 100 can extract the text image in the detected text region and arrange the extracted text image in the positive direction. The text image can include a letter and/or number having various sizes and lengths.

At step S330, the vehicle mileage recognizing apparatus 100 can dispose the text image in the positive direction or the positive angle by using the perspective transformation. The text image arranged in the positive direction or the positive angle can raise the recognition rate of text recognition.

The vehicle mileage recognizing apparatus 100 can convert the text region of various shapes including the text image into a rectangular shaped box through a matrix multiplication operation of the transformation matrix of the perspective transformation.

The vehicle mileage recognizing apparatus 100 can output the coordinates of each of the vertices of the converted rectangular shaped box. The vehicle mileage recognizing apparatus 100 can fix coordinates of four vertices vertically and horizontally, and at the same time, maintain the height and width of the text image.

The vehicle mileage recognizing apparatus 100 can finally generate the text image obtained by aligning the rotated text image in the positive angle through the perspective transformation.

The vehicle mileage recognizing apparatus 100 can convert the form of the text image arranged in the positive direction.

The vehicle mileage recognizing apparatus 100 can clearly create the object boundary through adjustment of brightness and contrast, and can perform pre-processing with respect to the text image such that the OCR model can perform accurate recognition.

At step S340, the vehicle mileage recognizing apparatus 100 can convert the text image to black and white by using the style transfer.

The style transfer can process the initial image into black and white to remove noise and invert colors, thereby clarifying the object boundary. The text image converted into black and white has a high recognition rate. The text image converted into black and white has clear boundary of the text, thereby providing a high recognition rate.

The vehicle mileage recognizing apparatus 100 can invert the color at each pixel position through the style transfer, and can remove the noise by black-and-white processing.

At step S350, the vehicle mileage recognizing apparatus 100 can recognize a text by using the OCR model with respect to the text image of which the form has been converted.

The vehicle mileage recognizing apparatus 100 can recognize text by using the plurality of OCR models. The plurality of OCR models can include the 7-segment font dedicated model.

The vehicle mileage recognizing apparatus 100 can generate a plurality of recognition results through the plurality of OCR models. The plurality of recognition results can include the recognized text, respectively.

For example, the plurality of recognition results can include texts recognized through the 7-segment font dedicated model and texts recognized through the general font dedicated model.

At step S360, the vehicle mileage recognizing apparatus 100 can detect the recognition target text with respect to each of the recognized texts through post-processing. The recognition target text can be a text representing the mileage among the recognized texts.

The vehicle mileage recognizing apparatus 100 can post-process the model recognition result in 3 manners.

The vehicle mileage recognizing apparatus 100 can detect the recognition target text by using a text pre-processing method, a longest text pre-processing method and a box size outlier pre-processing method as a post process.

That is, the vehicle mileage recognizing apparatus 100 can specify the text determined as representing the mileage through post-processing.

The vehicle mileage recognizing apparatus 100 can detect the text representing the mileage as the recognition target text among the texts recognized through the 7-segment font dedicated model. The vehicle mileage recognizing apparatus 100 can detect the text representing the mileage as the recognition target text among the texts recognized through the general font dedicated model.

That is, the recognition target text can be in a plural quantity as being detected for each model.

At step S370, the vehicle mileage recognizing apparatus 100 can confirm whether the recognition target image has been rotated based on the recognition target text.

The vehicle mileage recognizing apparatus 100 can detect the rotation angle of the recognition target image based on the recognition target text.

At step S380, the vehicle mileage recognizing apparatus 100 can recognize the final text selected from the recognition target text and determine it as the mileage.

The vehicle mileage recognizing apparatus 100 can select the text finally determined as the mileage from the recognition target texts, based on whether the recognition target text has been rotated and rotation angle.

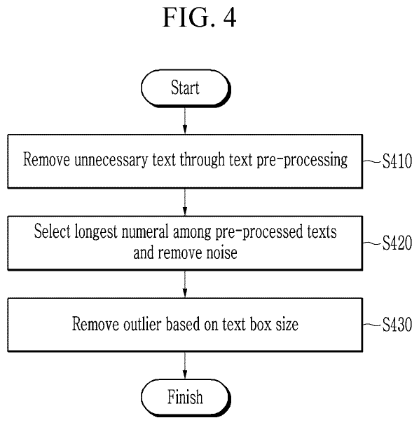

FIG. 4 is a flowchart of a vehicle mileage recognizing method according to an implementation. FIG. 4 shows a post-processing method according to a vehicle mileage recognizing method according to an implementation.

At step S410, in FIG. 4, the vehicle mileage recognizing apparatus 100 can remove an unnecessary text through a string-based pre-processing of the recognized texts.

For example, when there is a blank space within the text, the vehicle mileage recognizing apparatus 100 can delete the plank space.

In addition, the vehicle mileage recognizing apparatus 100 can remove the text having a string of a length of 2 or less.

In addition, the vehicle mileage recognizing apparatus 100 can remove the text having a special letter between numbers in a string.

At step S420, the vehicle mileage recognizing apparatus 100 can select the text of the longest numeral among the texts pre-processed based on strings, and remove noise.

The vehicle mileage recognizing apparatus 100 can remove remaining texts excluding a text in which the length of the longest numeral is 4 to 7 digits. This is because the mileage of the vehicle is generally within 4 to 7 digits.

When the longest numeral is a type of instrument panel false recognition, the vehicle mileage recognizing apparatus 100 can remove a corresponding text.

That is, the vehicle mileage recognizing apparatus 100 can eliminate the case that numbers such as 100, 110, 120, or the like, on the instrument panel are combined and recognized as 100110, 100120, 110120, or the like, and falsely recognized as the mileage.

At step S430, the vehicle mileage recognizing apparatus 100 can remove outlier based on the size of the text box.

The vehicle mileage recognizing apparatus 100 can obtain the average value of the width or length of the text box per letter, and remove the outlier based on the average value.

The vehicle mileage recognizing apparatus 100 can remove outliers based on the value compensated for the height in each text box's box width or length.

That is, the vehicle mileage recognizing apparatus 100 can remove the case in which a very great number is false-recognized in a very small box region due to an error in the deep learning model.

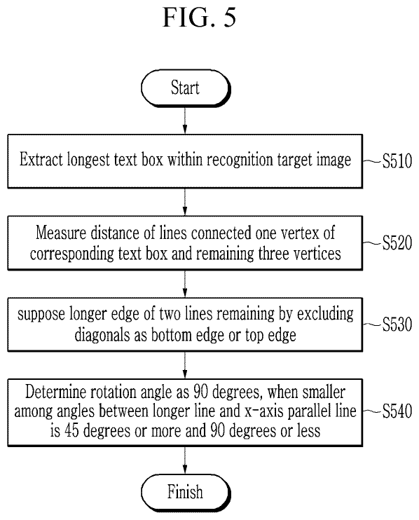

FIG. 5 is a flowchart of a vehicle mileage recognizing method according to an implementation. FIG. 5 shows a rotation confirming method of a vehicle mileage recognizing method according to an implementation.

In FIG. 5, at step S510, the vehicle mileage recognizing apparatus 100 can extract the longest text box within the recognition target image.

At step S520, the vehicle mileage recognizing apparatus 100 can measure the distance of lines connecting one vertex and remaining three vertices of the corresponding text box.

At step S530, the vehicle mileage recognizing apparatus 100 can assume a longer line among two lines excluding diagonal lines as a bottom side or a top side.

At step S540, when the smaller angle among angles between the longer line and the x-axis parallel line is 45 degrees or more and 90 degrees or less, the vehicle mileage recognizing apparatus 100 can determine the rotation angle as 90 degrees. When the rotation angle is 90 degrees, the input image can be confirmed as being inputted while having been rotated by 90 degrees.

Therefore, the vehicle mileage recognizing apparatus 100 can confirm that the recognition target image has been obtained while the input image has been rotated by 90 degrees.

Distances between one vertex and remaining vertices in the text region can be obtained based on the text region of the rectangular shape of the longest length including the recognition target text, and the longest line among remaining lines excluding diagonal lines can be selected.

When the smaller angle among angles between the selected longest line and the x-axis parallel line is 45 degrees or more and 90 degrees or less, the vehicle mileage recognizing apparatus 100 can determine the rotation angle of the recognition target image as 90 degrees.

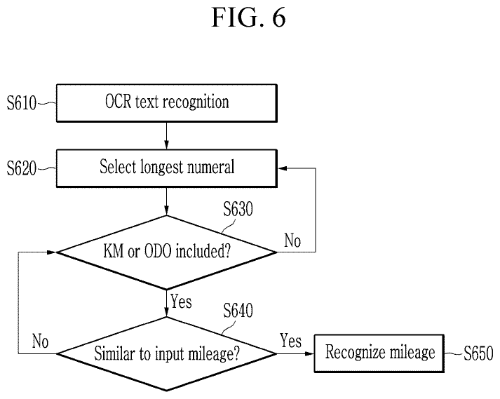

FIG. 6 is a flowchart of a vehicle mileage recognizing method according to an implementation. FIG. 6 shows a text recognition-based mileage recognizing method through an OCR model according to an implementation.

At step S610, in FIG. 6, the vehicle mileage recognizing apparatus 100 can recognize the text within the text image through the OCR model.

At step S620, the vehicle mileage recognizing apparatus 100 can select the text including the longest numeral among the recognized texts as the recognition target text.

When the recognition target text includes the specific character representing the mileage, the vehicle mileage recognizing apparatus 100 can determine the recognition target text as the final recognition target text. The specific character can be KM or ODO.

At step S630, for example, the vehicle mileage recognizing apparatus 100 can determine whether the recognition target text includes KM or ODO.

When the recognition target text does not include the specific character, the vehicle mileage recognizing apparatus 100 can exclude a corresponding text, and can re-select the longest text among the texts including the specific character as the final recognition target text.

For example, when the recognition target text does not include KM or ODO, the vehicle mileage recognizing apparatus 100 can select the longest text among the texts including KM or ODO.

The vehicle mileage recognizing apparatus 100 can compare the final recognition target text with the input mileage inputted by a user, and thereby can recognize the most similar final recognition target text as the final text, and determine the recognized final text as the mileage.

That is, at step S640, when the recognition target text includes KM or ODO, the vehicle mileage recognizing apparatus 100 can determine whether the corresponding recognition target text is similar to the input mileage inputted by a user.

When the corresponding recognition target text is not similar to the input mileage, the vehicle mileage recognizing apparatus 100 can determine whether the text including a subsequently the longest numeral includes KM or ODO.

When the corresponding recognition target text is determined to be similar to the input mileage, the vehicle mileage recognizing apparatus 100 can finally determine the corresponding recognition target text as the mileage.

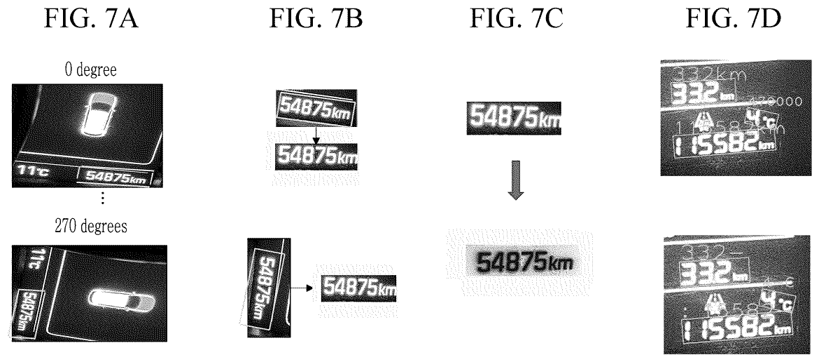

FIGS. 7A-7D are example illustrations of a vehicle mileage recognizing method according to an implementation. FIG. 7 is an example diagram showing steps of the mileage recognizing method with reference to FIG. 1 to FIG. 6.

FIG. 7A shows the recognition target image obtained by rotating the input image by 0 degree and 270 degrees. FIG. 7A shows that the text region is detected from the recognition target images, respectively, and the text region is marked by rectangular box.

FIG. 7B shows that the text image extracted from the text region marked in by rectangular box is arranged in parallel in the positive direction through the perspective transformation.

FIG. 7C shows that the text image arranged in the positive direction is converted into black and white through the style transfer.

FIG. 7D shows that texts are recognized through the OCR model from the text images included in the recognition target image.

In FIG. 7D, a first one shows that the text is recognized through the 7-segment font dedicated model, and a second one shows that the text is recognized through the general font dedicated model.

Since a 7-segment font is the object, when the text is recognized through the 7-segment font dedicated model, the recognition confidence appears to be high.

The vehicle mileage recognizing apparatus 100 can detect the text corresponding to the mileage among the texts recognized through post-processing with the recognition results through the OCR models.

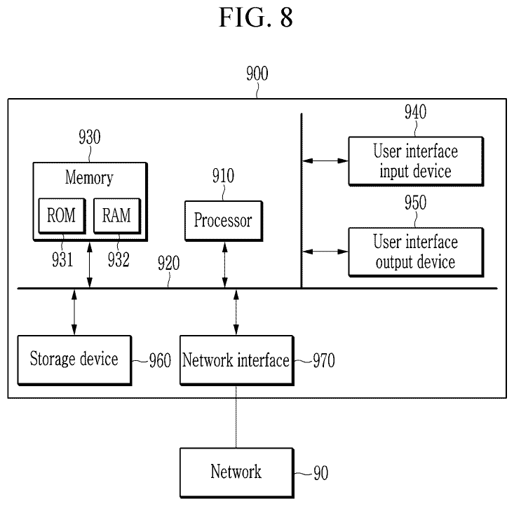

FIG. 8 is drawing for explaining a computing device according to an implementation.

Referring to FIG. 8, a vehicle mileage recognizing method and apparatus according to implementations can be implemented by using a computing device 900.

The computing device 900 can include at least one of a processor 910, a memory 930, the user interface input device 940, the user interface output device 950 and a storage device 960 that communicate through a bus 920. The computing device 900 can also include a network interface 970 electrically connected to a network 90. The network interface 970 can transmit or receive signals with other entities through the network 90.

The processor 910 can be implemented in various types such as a micro controller unit (MCU), an application processor (AP), a central processing unit (CPU), a graphic processing unit (GPU), a neural processing unit (NPU), and the like, and can be any type of semiconductor device capable of executing instructions stored in the memory 930 or the storage device 960. The processor 910 can be configured to implement the functions and methods described above with respect to FIGS. 1 to 7.

The memory 930 and the storage device 960 can include various types of volatile or non-volatile storage media. For example, the memory can include read-only memory (ROM) 931 and a random-access memory (RAM) 932. In this implementation, the memory 930 can be located inside or outside processor 910, and the memory 930 can be connected to the processor 910 through various known means.

In some implementations, at least some components or functions of a vehicle mileage recognizing method and apparatus can be implemented as a program or software running on the computing device 900, and the program or software can be stored in a computer-readable medium.

In some implementations, at least some components or functions of a vehicle mileage recognizing method and apparatus can be implemented using hardware or circuit of the computing device 900 or can be implemented as separate hardware or circuit that can be electrically connected to the computing device 900.

While this disclosure has been described in connection with what is presently considered to be practical implementations, it is to be understood that the disclosure is not limited to the disclosed implementations, but, on the contrary, is intended to cover various modifications and equivalent arrangements included within the spirit and scope of the appended claims

What is claimed is:

1. A vehicle mileage recognition method, comprising:
obtaining an input image including a vehicle mileage, the input image corresponding to a recognition target image;
detecting a text region from the recognition target image;
extracting a text image in the text region;
arranging the text image in an upright position;
modifying an appearance or structure of the text image that is arranged in the upright position;
recognizing, within a modified text image, a text by using an Optical Character Recognition (OCR) model;
detecting, based on the text that is recognized by using the OCR model, a recognition target text;
determining, based on the recognition target text, a rotation angle of the recognition target image; and
recognizing, based on the rotation angle, a final text from the recognition target text and determining the final text as the vehicle mileage.

2. The vehicle mileage recognition method of claim 1, wherein obtaining the input image comprises:
obtaining, among a plurality of recognition target images that are rotated in one or more 90-degree increments from 0 to 270 degrees, at least one target image.

3. The vehicle mileage recognition method of claim 1, wherein detecting the text region from the recognition target image comprises:
detecting the text region based on a Character Region Awareness for Text Detection (CRAFT) model.

4. The vehicle mileage recognition method of claim 1, wherein arranging the text image in the upright position comprises:
arranging, based on a perspective transformation, the text image in the upright position or at a specific angle corresponding to the upright position.

5. The vehicle mileage recognition method of claim 1, wherein the modifying the appearance or structure of the text image that is arranged in the upright position comprises:
converting, based on a style transfer, the text image into black and white color.

6. The vehicle mileage recognition method of claim 1, wherein recognizing the text by using the OCR model comprises:
recognizing the text by using a plurality of OCR models,
wherein the plurality of OCR models comprise a 7-segment font dedicated model.

7. The vehicle mileage recognition method of claim 1, wherein detecting, based on the text that is recognized by using the OCR model, the recognition target text comprises:
detecting the recognition target text by performing a text pre-processing technique, a longest text pre-processing technique, and a box size outlier pre-processing technique.

8. The vehicle mileage recognition method of claim 7, wherein performing the longest text pre-processing technique comprises:
removing remaining text except for a specific text having a specific length, the specific length being indicative of the vehicle mileage.

9. The vehicle mileage recognition method of claim 1, wherein determining, based on the recognition target text, the rotation angle of the recognition target image comprises:
based on a text region having rectangular shape with a longest length and including the recognition target text:
determining distances between one vertex and remaining vertices in the rectangular shape of the text region, and selecting a longest line among lines that define the rectangular shape, the lines excluding diagonal lines, and
determining the rotation angle of the recognition target image as 90 degrees based on a smaller angle, among angles formed between the longest line and a line that is parallel to an x-axis, being 45 degrees or more and 90 degrees or less.

10. The vehicle mileage recognition method of claim 1, wherein recognizing the final text from the recognition target text and determining the final text as the vehicle mileage comprise:
based on a determination that the recognition target text includes a specific character that is indicative of the vehicle mileage, determining the recognition target text as a final recognition target text,
based on a determination that the recognition target text does not include the specific character, determining, as the final recognition target text, a longest text among the text that includes the specific character,
comparing a plurality of final recognition target texts with an input mileage that is provided by a user,
recognizing, among the plurality of final recognition target texts, a most similar final recognition target text to the input mileage as the final text, and
determining that the final text represents the vehicle mileage.

11. A vehicle mileage recognition apparatus, comprising:
a text detection unit configured to detect a text region from a recognition target image, the recognition target image corresponding to an input image that includes a vehicle mileage and that is rotated;
a pre-processing unit configured to extract a text image in the text region and arrange the text image in an upright position and configured to modify an appearance or structure of the text image that is arranged in the upright position;
a text recognition unit configured to, based on a use of an Optical Character Recognition (OCR) model, recognize a text within a modified text image;
a post-processor (i) configured to, based on the text that is recognized by using the OCR model, detect a recognition target text, and (ii) configured to, based on the recognition target text, determine a rotation angle of the recognition target image; and
a mileage determiner configured to, based on the rotation angle, recognize a final text from the recognition target text and determine the final text as the vehicle mileage.

12. The vehicle mileage recognition apparatus of claim 11, wherein the text detection unit is configured to obtain at least one target image among a plurality of recognition target images that are rotated in one or more 90-degree increments from 0 to 270 degrees.

13. The vehicle mileage recognition apparatus of claim 11, wherein the text detection unit is configured to a detect the text region based on a Character Region Awareness for Text Detection (CRAFT) model.

14. The vehicle mileage recognition apparatus of claim 11, wherein the pre-processing unit is configured to, based on a perspective transformation, arrange the text image in the upright position or at a specific angle corresponding to the upright position.

15. The vehicle mileage recognition apparatus of claim 11, wherein the pre-processing unit is configured to, based on a style transfer, convert the text image into black and white color.

16. The vehicle mileage recognition apparatus of claim 11, wherein the text recognition unit is configured to recognize the text by using a plurality of OCR models,
wherein the plurality of OCR models comprise a 7-segment font dedicated model.

17. The vehicle mileage recognition apparatus of claim 11, wherein the post-processor is configured to detect the recognition target text by performing a text pre-processing technique, a longest text pre-processing technique, and a box size outlier pre-processing technique.

18. The vehicle mileage recognition apparatus of claim 17, wherein performing the longest text pre-processing technique comprises:
removing remaining text except for a specific text having a specific length, the specific length being indicative of the vehicle mileage.

19. The vehicle mileage recognition apparatus of claim 11, wherein the post-processor is configured to, based on a text region having rectangular shape with a longest length and including the recognition target text:
determine distances between one vertex and remaining vertices in the rectangular shape of the text region, and selecting a longest line among lines that define the rectangular shape, the lines excluding diagonal lines, and
determine the rotation angle of the recognition target image as 90 degrees based on a smaller angle, among angles formed between the longest line and a line that is parallel to an x-axis, being 45 degrees or more and 90 degrees or less.

20. The vehicle mileage recognition apparatus of claim 11, wherein the mileage determiner is configured to:
based on a determination that the recognition target text includes a specific character that is indicative of the vehicle mileage, determine the recognition target text as a final recognition target text,
based on a determination that the recognition target text does not include the specific character, determine, as the final recognition target text, a longest text among the text that includes the specific character,
compare a plurality of final recognition target texts with an input mileage that is provided by a user,
recognize, among the plurality of final recognition target texts, a most similar final recognition target text to the input mileage as the final text, and
determine that the final text represents the vehicle mileage.
